(19) United States
(12) Patent Application Publication
(10) Pub. No.: US 2012/0065280 A1
(43) Pub. Date: Mar. 15, 2012

(54) METHOD, PROCESS AND DEVICE FOR POLYMERIC WASTE PROCESSING

(75) Inventors: Michael Vainer, Caulfield, VIC (AU); Boris Rozenblit, Hampton, VIC (AU)

(73) Assignee: VR TEK PTY LTD, Highett, VIC (AU)

(21) Appl. No.: 13/321,387

(22) PCT Filed: May 3, 2010
(86) PCT No.: PCT/AU10/00507

§ 371 Date: Nov. 18, 2011

(30) Foreign Application Priority Data
May 20, 2009 (AU) 2009902282

(51) Int. Cl. C08J 11/04; B01J 19/00

(52) U.S. Cl. 521/41; 422/187

(57) ABSTRACT

A method and device for processing of polymeric waste which may be associated with elements such as non-polymeric material or metals. In a specific embodiment the method includes the steps of (1) loading preliminarily deformed waste into a reaction chamber, (2) applying an aggressive medium to the waste for a time sufficient to convert the one or more polymers to fragments, and separate one of more polymers from their associated elements, and (3) subjecting the products of step (2) to mechanical separation of the associated elements from the polymer fragments. The method and device is particularly useful for the processing of tires including preliminarily deformed tire segments or shredded tire waste.

### FIELD OF THE INVENTION

The present invention relates generally to polymeric waste processing. More particularly, the present invention relates to processing of polymeric waste which may be associated with non-polymeric material or metals.

In a particular embodiment the present invention relates to polymeric waste incorporating metal reinforcement such as used tyres, conveyer belts, breathing apparatus, and the like. The present invention further relates to a waste processing device and method of treating the polymeric waste.

While it will be convenient to describe the present invention with reference to part of a tyre decomposition process, the invention is not limited to that application, and may be used for other types of polymeric waste to provide a product that can then be used in other applications.

### BACKGROUND OF THE INVENTION

The discussion throughout this specification comes about due to the realisation of the inventor and/or the identification of certain related art problems by the inventor and, moreover, any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein and in the inventor's Australian Provisional Patent 2009902282.

Tyre Waste

Polymeric waste, such as used tyres, has become a worldwide economic and ecological problem. Tyres include a wide range of polymers including natural rubber co-polymers and synthetic rubbers such as SBR (styrene butadiene rubber) and butadiene rubber, nitride rubber, isoprene rubber, neoprene rubber and polysulphide rubber. Tyres also include metals such as zinc and steel. A large variety of other organic and inorganic chemicals are also added to tyre polymers including vulcanising agents, accelerators, retardants, pigments, fillers, associated agents, softeners, anti-oxidants, anti-ozonants and desiccants.

Disposal

Furthermore, the polymers in tyres are only part of the overall structure. The rubber is intimately connected to tyre reinforcements such as belts made of steel wire or textile fabric and wire cords.

The vast majority of current methods for disposal of end-of-life tyres not only represents economic waste of polymers as raw materials but also contributes to ecological problems associated with the practises of dumping in land and marine environments. In particular, leaching of inorganic and organic chemicals from dumped tyres releases toxins into the environment, as well as posing a considerable fire hazard.

Some of the prior art methods used to address the problems associated with disposal of tyres include the following:
Combustion, being the burning of tyres. However, pollution is a serious problem associated with this method.
Pyrolysis, being the transformation process of rubber into carbon black together with gaseous and liquid organic compounds. However, this process consumes large amounts of energy due to the high temperatures involved and a low volume industrial usage of the resultant products.
Cryogenic methods, being the cooling of rubber products to make them brittle followed by mechanical destruction and the removing of the majority of associated elements. However, the high energy consumption required to provide sufficient volumes of liquid nitrogen and uniformly cool the rubber is a serious problem with this method, as is the inability to allow for selective processing of different qualities of rubber within the tyre.
Other mechanical rubber destruction methods such as the cutting and grinding of tyres. However, these methods suffer from problems associated with the lack of efficiency of separating the rubber from metal reinforcement, high energy consumption, high wearing of equipment and low product yields as well as the inability to allow for selective processing of different qualities of rubber within the tyre.
Regeneration, being the production of new mouldable products. However, regeneration processes tend to create a relatively high level of pollution.
Other methods of processing of rubber products include simultaneously exposing the rubber to mechanical loads and ozone containing gas to cause the rubber to burst and facilitate the separation of rubber from its reinforcement materials. These include for example, the methods and devices disclosed in EP 0 816 035 A1/B1 and U.S. Pat. No. 6,579,950 B2. The problems associated with these methods currently are that they are highly energy consuming, have complex construction creating a very difficult technical realisation of the device, contain complex tyre deformation devices inside the ozone containing chamber, have low productivity, and do not allow for selective processing of different qualities of rubber within the tyre.
Further, specific reference is made to differences of the present invention in relation to the following prior art:
1. LT 2004025 A, whereby the present invention importantly utilises preliminary deformation of polymeric waste and its resultant material characteristics, with the said preliminary deformation of the polymeric waste occurring outside of the reaction chamber of the present invention prior to its entry into the said reaction chamber and prior to contact with an aggressive medium such as ozone gas. Additionally, in the present invention the aggressive medium may be admitted into the reaction chamber sweeping out any air that is present or alternatively, the casing may be evacuated prior to admission of the aggressive medium to the reaction chamber.
   The present invention also addresses the following disadvantages of this prior art wherein the repeat application of the ozone gas aggressive medium in the process of this prior art is directed at pulverised rubber containing waste product which is no longer under deformational strain and is therefore not significantly effected by the aggressive medium whilst such repeat application of the aggressive medium adds overall complexity to the device of the prior art. In addition, the mechanical deformation devices of the prior art situated inside the ozone containing medium are a safety concern due to the sparks potentially occurring leading to a potential explosion, whilst the present invention incorporates explosion-proof safety requirements for ozone gas, particularly in relation to ozone and polymeric dust mixtures. Further, this prior art has no specific means for the cleaning of the rubber containing waste product prior to the application of the ozone gas aggressive medium, whereas the present invention utilises a simple pneumatic cleaning system for this purpose.
2. EP 2106893 A1, whereby the present invention importantly enables the simultaneous fragmentation of the polymers within the polymeric waste and the separation of the said polymers from their reinforcing elements. The present invention also addresses the following disadvantages of this prior art wherein the construction and methodology of this prior art is complex in trying to utilise both an aggressive gas and a quick-freeze process. In addition, this prior art does not reuse the aggressive gas. Further, this prior art utilises a washing system for the cleaning of the rubber containing waste product prior to the application of the ozone gas aggressive medium which not only wastes water but also requires an energy consuming drying system, noting that in the example of waste tyres it is practically very difficult to totally evacuate water from the internal area of the tyre, whereas the present invention utilises a simple pneumatic cleaning system for this purpose.
3. U.S. Pat. No. 6,579,950 B2, whereby the present invention importantly does not require the aggressive gas ozone to be of high concentration, stated in this prior art to be preferably of at least 10 wt %, to act intensively on the region of the rubber waste under load of tension within the reaction chamber since the present invention utilises preliminary deformation of polymeric waste and its resultant material characteristics, with the said preliminary deformation of the polymeric waste occurring outside of the reaction chamber of the present invention prior to its entry into the said reaction chamber and prior to contact with an aggressive medium such as ozone gas. Thus different lower ozone gas concentrations can be utilised by the present invention, enabling efficient selective fragmentation of different polymeric wastes being separately fed into the reaction chamber, the different polymeric wastes having different material qualities and characteristics.
   The present invention also addresses the following disadvantages of this prior art wherein, in the example of fragmenting used tyres, during the prior art's process, the rubber in and around the bead is not fully deformed by the cylindrical rollers whereby effective fragmentation of the associated hard rubber is very difficult. Further, this prior art incorporates a high energy consuming deformation process inside the reaction chamber via the cylindrical rollers, especially so with the need to reverse their rotation. Additionally, the mechanical deformation devices of the prior art situated inside the ozone containing medium are a safety concern due to the sparks potentially occurring leading to a potential explosion, whilst the present invention incorporates explosion-proof safety requirements for ozone gas, particularly in relation to ozone and polymeric dust mixtures.
4. U.S. Pat. No. 5,492,657 A, whereby the present invention importantly does not require the aggressive gas ozone to be of high concentration, stated in this prior art to be up to 30% by weight, to act on the rubber waste under load of tension within the reaction chamber since the present invention utilises preliminary deformation of polymeric waste and its resultant material characteristics, with the said preliminary deformation of the polymeric waste occurring outside of the reaction chamber of the present invention prior to its entry into the said reaction chamber and prior to contact with an aggressive medium such as ozone gas. Thus different lower ozone gas concentrations can be utilised by the present invention, enabling efficient selective fragmentation of different polymeric wastes being separately fed into the reaction chamber, the different polymeric wastes having different material qualities and characteristics. The present invention also addresses the following disadvantages of this prior art wherein the removal of reinforcement materials is not as efficient as that of the present invention since it needs to occur after the polymer fragmentation process outside of the reaction chamber as depicted in FIG. 1 of the prior art, whilst the present invention enables simultaneous removal of the reinforcement materials during the polymer fragmentation process inside of the reaction chamber. Further, this prior art in the example of used tyre reprocessing process only a single tyre at time, even if processed in series, whilst the present invention enables simultaneous reprocessing of many tyre and/or tyre segment batches. Additionally, the present invention removes the need for the frequent opening and closing of sluice gates which in the prior art results in the potential escape of the ozone gas thus reducing the effectiveness of the process and a danger to the environment and human population. Also, the mechanical deformation devices of the prior art situated inside the ozone containing medium are a safety concern due to the sparks potentially occurring leading to a potential explosion, whilst the present invention incorporates explosion-proof safety requirements for ozone gas, particularly in relation to ozone and polymeric dust mixtures. In addition, the preliminary deformation of the polymeric waste of the present invention outside of the reaction chamber removes the need of this prior art's high energy consuming forces being required for deformation of polymeric waste inside the reaction chamber such as a mechanical load of 0.5 kg/cm².
5. WO 2007/061280 A1, whereby the present invention importantly does not require a chemical pre-treatment step nor a cryogenic cooling step prior to disintegrating polymeric waste instead utilising an aggressive medium such as ozone gas, as the chemical pre-treatment changes the material composition of the polymers being reprocessed and cryogenic cooling is a more energy intensive and costly process than that of the present invention.
   The present invention also addresses the following disadvantages of this prior art wherein utilising chemical means to pre-treat waste rubber increases its temperature whereby necessitating a further cooling step such a cryogenics to reduce the temperature necessarily making the process more energy consuming and expensive, this not being required by the present invention. Further, the cryogenic process alone of the prior art is more expensive than the process of the present invention, and the disintegration of the polymeric waste which occurs after this cryogenic process will in the example of used tyres simultaneously disintegrate and mix the different hard and soft rubber within the tyre together with their reinforcing elements such as metal, thus cross-contaminating and reducing the quality of, the resultant rubber powder output, unlike the process of the present invention which can selectively process the different hard and soft rubber within the tyre and simultaneously separate them from their reinforcing elements such as metal.
6. EP 1016508 A1, whereby importantly the preliminary deformation of the polymeric waste of the present invention outside of the reaction chamber removes the need of this prior art's high energy consuming forces being required for deformation of polymeric waste inside the reaction chamber. Further, with the said preliminary deformation of the polymeric waste occurring outside of the reaction chamber of the present invention prior to its entry into the said reaction chamber and prior to contact with an aggressive medium such as ozone gas, different lower ozone gas concentrations can be utilised by the present invention, enabling efficient selective fragmentation of different polymeric wastes being separately fed into the reaction chamber, the different polymeric wastes having different material qualities and characteristics.
   The present invention also addresses the following disadvantages of this prior art wherein the mechanical deformation process of the prior art occurring inside the ozone containing medium is a safety concern due to the sparks potentially occurring leading to a potential explosion, whilst the present invention incorporates explosion-proof safety requirements for ozone gas, particularly in relation to ozone and polymeric dust mixtures.
7. EP 0816035 A1, whereby importantly the preliminary deformation of the polymeric waste of the present invention outside of the reaction chamber removes the need of this prior art's high, energy consuming forces being required for deformation of polymeric waste inside the reaction chamber. Further, with the said preliminary deformation of the polymeric waste occurring outside of the reaction chamber of the present invention prior to its entry into the said reaction chamber and prior to contact with an aggressive medium such as ozone gas. Thus different lower ozone gas concentrations can be utilised by the present invention, enabling efficient selective fragmentation of different polymeric wastes being separately fed into the reaction chamber, the different polymeric wastes having different material qualities and characteristics.
   The present invention also addresses the following disadvantages of this prior art wherein the mechanical deformation process of the prior art occurring inside the ozone containing medium is a safety concern due to the sparks potentially occurring leading to a potential explosion, whilst the present invention incorporates explosion-proof safety requirements for ozone gas, particularly in relation to ozone and polymeric dust mixtures. Additionally, this prior art as depicted in FIG. 2 separates the resultant materials from the process less efficiently outside of the reaction chamber, whilst the present invention enables separation of the resultant materials from the process and the simultaneous removal of the reinforcement materials during the polymer fragmentation process inside of the reaction chamber. Also, according to claim 3 of this prior art, the temperature range of the process is between 10° C. and 110° C. thus incorporating temperatures into the process that degrade ozone gas and make it less effective during the reaction process, whilst the present invention does not require nor generate such high temperatures.
8. RU 2123425 C1, whereby again importantly the preliminary deformation of the polymeric waste of the present invention outside of the reaction chamber removes the need of this prior art's high energy consuming forces being required for deformation of polymeric waste inside the reaction chamber. Also further, with the said preliminary deformation of the polymeric waste occurring outside of the reaction chamber of the present invention prior to its entry into the said reaction chamber and prior to contact with an aggressive medium such as ozone gas, different lower ozone gas concentrations can be utilised by the present invention, enabling efficient selective fragmentation of different polymeric wastes being separately fed into the reaction chamber, the different polymeric wastes having different material qualities and characteristics.
   The present invention also addresses the following disadvantages of this prior art wherein again the mechanical deformation process of the prior art occurring inside the ozone containing medium is a safety concern due to the sparks potentially occurring leading to a potential explosion, whilst the present invention incorporates explosion-proof safety requirements for ozone gas, particularly in relation to ozone and polymeric dust mixtures. Additionally, again unlike this prior art, the present invention efficiently enables separation of the resultant materials from the process and the simultaneous removal of the reinforcement materials during the polymer fragmentation process inside of the reaction chamber.

It would therefore be desirable to provide an alternative process, method and apparatus for processing polymeric waste that overcomes some or all of the drawbacks of the processes, methods or devices of the prior art.

In particular there is a need for a process that can provide polymer crumb tailored to suit the requirements of downstream manufacturing processes.

### SUMMARY OF THE INVENTION

An object of the present invention is to provide a more efficient process for breaking down waste containing polymer and separating associated material in the waste from the polymer, where the associated elements may include non-polymeric materials such as metal as well as polymeric materials such as acrylic fibres.

An object of the present invention is to provide a process, method and device that can provide polymer crumb tailored to suit the requirements of downstream uses.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

It is a further objective of the present invention to selectively process different qualities of polymer, for example separately processing the soft or hard rubber segments of a tyre.

In a first embodiment there is provided a method for processing waste comprising one or more polymers and non-polymers, the method comprising the steps of,
1 loading preliminarily deformed waste into a reaction chamber,
2 applying an aggressive medium to the waste for a time sufficient to convert the one or more polymers to fragments, and separate one or more polymers from their associated elements, and
3 subjecting the products of step 2 to mechanical separation of the associated elements from the polymer fragments.

In one variation of this embodiment, after step 2 the separated polymer fragments pass through a sieve operatively connected to the reaction chamber for collection.

In a particularly preferred embodiment the mechanical separation is carried out using a riddle. The waste may be located within the riddle during the processing. Accordingly, there is further provided a method for processing waste comprising one or more polymers and associated elements, the method comprising the steps of,
1 loading preliminarily deformed waste into a riddle associated with a reaction chamber,
2 applying an aggressive medium to the waste for a time sufficient to cause (i) at least some separation of the one or more polymers from associated elements, and (ii) at least some breakdown of the one or more polymers to form fragments including crumb, and
3 passing the product of step 2 through the riddle such that at least some of the associated elements are retained within the riddle.

Where used herein the term waste polymer is intended to be interpreted broadly, for example, to refer to polymer that is no longer required for its originally intended use or that is created as excess, over-run or a by-product of an industrial process. The associated element is typically metallic, such as the associated steel belt of a radial tyre, but may also include non-metallic elements such as the acrylic cloth used to line the inside wall of tyres. The term ‘associated’ is to be interpreted broadly to not only include elements that provide structural integrity to the waste but also to provide functional integrity such as the cloth associated with a rubber face mask.

Where used herein the term ‘aggressive medium’ is intended to be interpreted broadly, for example, to refer to an agent that causes polymeric decomposition chosen from the group comprising gas, liquid, or combinations thereof and at any convenient temperature.

Where used herein the term ‘fragment’ refers to particulate product and may include crumb. The fragments typically range from quite large particles up to a few centimetres in size and larger, to quite small particles and dust. The term ‘crumb’ is often used to refer to particles that are a smaller sub-measurement of fragments. The application time of the aggressive medium will be controlled to provide the desired range of crumb size.

Preliminary Deformation

Preliminary deformation enables the stretching, compression and partial bending of the polymeric waste. The waste can be preliminarily deformed by, for example, firstly cutting it up into segments and then applying bending, compressional, torsional or other force to maintain physical stress on the waste, or applying bending, compressional, torsional or other force to maintain physical stress on the waste without prior segmentation.

Typically, when the waste comprises tyres, the tyres may be preliminarily deformed by
(i) cutting or shredding each tyre and then applying bending, compressional, torsional or other force to maintain physical stress on the shredded waste such as, for example, landfill, or
(ii) selectively segmenting each tyre into ring-like segments of different qualities of required material composition and then applying bending, compressional, torsional or other force to maintain physical stress and maintaining the tyre segments in a bended conformation, or
(ii) applying bending, compressional, torsional or other force to maintain physical stress on an entire tyre and maintaining entire tyres in a bent or contorted conformation.

For example, a segmented or whole tyre can be maintained in a bent or flexed state by the use of retaining means such as ties, clips or other fasteners. Tyre pieces can be, for example, confined during and after bending, compression, or torsion within a bag. These retaining means may be constructed from materials that react with the aggressive medium.

The preferred method for processing end-of-life tyres is utilising the above preliminary deformation method (ii) that is, selectively segmenting each tyre into ring-like segments of different qualities. Preliminary deformation on such segments requires less force and less energy, and allows for selective processing of different qualities of rubber. In this manner for example, soft rubber within a tyre can be processed separately to the hard rubber within a tyre.

Additional deformation or compression of the tyre can be achieved, if necessary, without the application of great force, and without adding to the complexity of the method or device.

Typically, the reaction chamber incorporates a riddle, where the riddle comprises a grill, mesh or perforated container. In one embodiment the riddle is integral with the reaction chamber. In another embodiment, the riddle can be removably located in relation to the chamber. In all embodiments, the riddle can incorporate protrusions that extend internally to assist with any required additional deformation of the preliminarily deformed polymeric waste pieces and Mechanical separation of any partially fragmented polymers resulting from the reaction with the aggressive medium.

When the application of aggressive medium to the polymer has been completed, the resultant polymer fragments can readily pass through the apertures in the riddle. By contrast, associated elements such as metal belts, wire or acrylic fibres, and pieces of associated, elements still attached to polymer may not be sufficiently decomposed by the aggressive medium and may not pass through the apertures in the riddle. Thus at least some of the associated elements and pieces of polymer still attached to associated elements are typically retained within the riddle of reaction chamber.

In a preferred embodiment the riddle can be removably located within a casing of the reaction chamber that can be hermetically sealed.

In a second embodiment the present invention provides a method for processing waste comprising one or more polymers and associated elements, the method comprising the steps of,
(1)(a) loading preliminarily deformed waste into a riddle associated with a reaction chamber,
(1)(b) hermetically sealing the reaction chamber,
(1)(c) admitting an aggressive medium into the sealed reaction chamber to a desired concentration,
(2) applying the aggressive medium to the waste for a time sufficient to cause (i) at least some separation of the one or more polymers from their associated elements, and (ii) at least some breakdown of the one or more polymers to form fragments including crumb, and
(3) passing the product of step 2 through the riddle such that at least some of the associated elements are retained within the riddle.

In a third embodiment the present invention provides a method for processing waste comprising one or more polymers and associated elements, the method comprising the steps of,
(1)(a) loading preliminarily deformed waste into a riddle associated with a reaction chamber,
(1)(b)(i) locating the riddle within the reaction chamber;
(1)(b)(ii) removing loose particulate matter from the reaction chamber to at least partially clean the preliminarily deformed waste,
(1)(c)(i) hermetically sealing the reaction chamber,
(1)(c)(ii) applying a vacuum to the sealed casing,
(1)(d)(i) admitting an aggressive medium into the sealed casing to a desired concentration,
(2)(i) applying the aggressive medium to the waste for a time sufficient to cause (i) at least some separation of the one or more polymers from their associated elements, and (ii) at least some breakdown of the one or more polymers to form fragments, and
(2)(ii) admitting air to the sealed reaction chamber to displace the aggressive medium,
(3)(i) passing the product of step 2 through the riddle such that at least some of the associated elements are retained within the riddle, and
(3)(ii) collecting the fragments passing through the riddle.

The polymer fragments pass through corresponding sized apertures in the riddle. The fragments can comprise a range of particle sizes from large particles to dust. Desired sub-ranges of particle sizes can be obtained by passing the fragments through a series of sieves of increasing mesh. Thus the fragments can be collected as separate products based on particle size.

The majority or at least a significant amount of polymer will be separated from the associated elements and pass through the riddle in their separated form. However, a percentage of small sized polymer particles that are still attached to their associated elements will also pass through the riddle and will only be separated from their associated elements by subsequent downstream processes.

Thus, the appropriate sub-ranges of particle sizes may then be subjected to any further desired steps such as processing in cyclone separators, magnetic separators, textile separators, sieves, degradation devices, neutralising barbotage or combinations thereof.

The associated elements, or particles of associated elements still attached to polymer, which do not pass through the riddle, are thus separated from the polymer fragments which do pass through the apertures in the riddle. When the waste comprises tyres, the associated elements typically include the steel mesh or belt, acrylic fibres and cloth, and metal cables. Some of the associated elements recovered may also be suitable for further processing, or in the case of metals, have resale value.

Preliminary Cleaning

Prior to application of an aggressive medium, the waste may be cleaned. Typically, when the waste is located in a casing, the casing is hermetically sealed and a vacuum applied to draw out small particular contaminants or a flow of air applied to sweep out contaminants. This is particularly effective when the waste comprises vehicle tyres which carry dirt and dust.

Further Deformation

The method may include application of further-force or deformation to the waste after it is loaded into the reaction chamber if necessary, without the application of great force, and without adding to the complexity of the method or device. Further such force or deformation may also be applied during the application of aggressive medium to the waste. The further force may be applied to the waste by any convenient means such as mechanical, pneumatic, electromagnetic, and/or ultrasonic operated devices. For example, a vibration table can be fitted to the riddle and/or reaction chamber. Additionally, deformation can be achieved by the mechanical compressional action of the components of the riddle. Further deformation can also be achieved by the inclusion of weighted apparatuses which can also be activated remotely to enhance their deformational effect on the waste.

The amount of any additional deformation required in the reaction chamber 2 of the waste disposal device will depend on the nature of the preliminarily deformed polymer waste. For example, segmented soft polymer will not require as much force as a whole used tyre. Waste disposal devices for processing the latter may necessarily have more drivers/devices inside their reaction chambers.

The polymeric waste processing device may therefore incorporate purposely positioned protrusions to assist with any required additional deformation of the preliminarily deformed polymeric waste pieces and also to assist with the mechanical separation of any partially fragmented polymers from the waste pieces resulting from the reaction with the aggressive medium.

Aggressive Medium

The aggressive medium may be applied by any convenient means. An aggressive gas may be applied neat, or in diluted form such as a mixture of gases or in a solution. For example, aggressive gasses suitable for the method of the present invention include ozone, oxygen, halogens such as chlorine and fluorine, acids including super-acids such as HF, strong alkalis, oxidising agents or combinations thereof. Further examples of aggressive media include cooling gases or liquids.

Many polymers, especially step-growth polymers, can be degraded by aggressive media. Synthetic polymers are typically made by condensation polymerization, so degradation is a reversal of this synthetic reaction.

Without wishing to be bound by theory, typically aggressive media causes breakdown of the one or more polymers by breaking chemical bonds within the polymer, thus rupturing the carbon chains and reducing the polymer to fragments. For example as little as 3 to 5 ppm of ozone will react in a thin surface layer (5×10⁻⁷ m) of natural rubber. Rupture of the carbon chains by ozone is increased in the presence of active hydrogen (for example, hydrogen in water, acids and alcohols) In addition cross linking and side branch formations occur and make the rubber material more brittle and more prone to forming cracks in areas of high stress. Applying a deformation force helps to propagate the cracks. As propagation of these cracks increases, new surfaces are opened for degradation to occur, and the original polymer is reduced to fragments.

In some polymers such as polyvinyl chloride (PVC) breakdown can also occur as a result of the formation, and then rupture of double bonds. For example the active hydrogen in acids remove the chloride from the carbon-chlorine bond in PVC forming hydrochloric acid (HCl). The HCl produced may then cause dechlorination of adjacent carbon atoms. The dechlorinated carbon atoms then tend to form double bonds, which can be attacked and broken by ozone, just like the degradation of natural rubber described above.

Application of Aggressive Media

The aggressive medium may be admitted into the reaction chamber, sweeping out any air that is present. Alternatively, the casing may be evacuated prior to admission of the aggressive medium to the reaction chamber. Irrespective of the method by which the aggressive medium is admitted, the appropriate concentration of an aggressive medium must be applied to the waste for the amount of time necessary to cause decomposition of the one or more polymers and their separation from their associated elements. Further, the temperature effect on an aggressive medium such as ozone gas must be taken into consideration, where increased temperatures cause the ozone gas to become less effective and therefore less beneficial in its action of fragmenting polymeric materials, whereby simultaneous consideration of ozone concentration and temperature is required for estimation of degradation of rubber, as demonstrated by such researchers as Tanaka and Koike (Simultaneous effects of ozone concentration and temperature on ozone degradation of rubber sheets—Institute of Technology, Tokyo, Japan 1991).

In one embodiment of the method of the present invention the required concentration is maintained by recirculating the aggressive medium inside the sealed casing. At the end of the aggressive medium application step the aggressive medium can be pumped out of the casing or displaced by pumping air or liquid into the casing.

In the case where the aggressive medium is a gas, the concentration of aggressive gas required to break chemical bonds varies from polymer to polymer. For example a higher concentration of aggressive gas is required to break the chemical bonds of hard, inelastic polymer close to or within the bead of a tyre, than the softer types of polymer elsewhere in the tyre. However, although prolonged exposure to a high concentration of aggressive gas will break bonds in hard polymer, softer, more elastic polymers can become over-exposed and unnecessarily degraded. Preferably, the method of the present invention does not use the maximum, highest concentration of aggressive gas for the entire duration of the processing: Instead, the quality of the batch of polymer waste is matched to an appropriate reaction time and concentration of aggressive gas.

The concentration of aggressive gas can be adjusted according to the different types and, qualities of polymer in the waste. For example, when the waste comprises tyres, separate batch processing can be carried out for the hard rubber near and within the bead of the tyre and the soft rubber in the tread or sidewalls of the tyre. This provides a purer, more consistent product due to the separate treatment of waste polymer, having been sorted by differing levels of hardness and elasticity of the rubber so as to produce different desired qualities of rubber crumb. In a particularly preferred embodiment, the waste polymer is sorted into batches according to different characteristics of hardness and elasticity. The different batches can be separately treated with appropriate concentrations of aggressive gas.

Optimally, the positioning of the preliminarily deformed polymeric waste pieces inside the riddle of the reaction chamber and their geometric shape ensures the aggressive medium is able to access the vast majority if not all of the surface area of the polymeric waste pieces. Observation windows for the reaction chamber can be utilised to observe the effectiveness of the reaction between the aggressive medium and the polymeric waste.

Also optimally, the aggressive medium will be reused in the same or other processes, to which for example a sectioned reaction chamber and/or a battery of reaction chambers lends itself.

Alternatively, it may be made less active or degraded by chemical conversion. For example, aggressive media such as ozone gas can readily be converted to oxygen by application of heat or chemical reaction with or without a catalyst.

Safety Features

It is important that the method is performed in an explosion proof mode, particularly in relation to ozone and polymeric dust mixtures. This can be achieved by using a control system that takes into account concentrations of the aggressive medium and any components with which it may react rapidly. These reactive components include particulate matter such as dust or dirt in the reaction chamber, feed lines or other parts of the system. Furthermore, any electrical device or machinery operated in conjunction with the method should be manufactured to explosion proof standards. Additionally, there should be a provision for anti-spark protection and protection from static electricity.

Important safety feature includes the ability to quickly neutralise and/or remove the aggressive media from the reaction chamber, as well as incorporating an explosion and/or fire prevention system and a fire fighting, fire containment and explosion containment systems.

In essence, embodiments of the present invention stem from the realization that subjecting waste containing polymers and non-polymers to deforming forces that increase the surface area and enable faster growth of cracks in the waste on which an aggressive medium can act thus assisting with processing of the waste. Processing of the waste includes breakdown of polymers into their constituents rendering them more susceptible to fragmentation and generation of a desired size. The process thus provides a more effective and economical reduction of the waste polymer to the desired quality and fragment size including crumb.

In a fourth embodiment the present invention provides a process for manufacturing a fragmented product from waste comprising one or more polymers and associated elements, the process comprising the steps of,
(1) loading preliminarily deformed waste into a reaction chamber,
(2) applying an aggressive medium to the waste for a time sufficient to cause (i) at least some separation of the one or more polymers from their associated elements, and (ii) at least some breakdown of the one or more polymers to form fragments including crumb, and
(3) passing the product of step 2 through a riddle such that at least some of the associated elements are retained within the riddle of the reaction chamber.

In a fifth embodiment the present invention provides a process for manufacturing a fragment product, from waste comprising one or more polymers and associated elements, the process comprising the steps of,
(1)(a) loading preliminarily deformed waste into a riddle,
(1)(b) locating the riddle within a reaction chamber,
(1)(c) hermetically Sealing the reaction chamber,
(1)(d) admitting an aggressive medium into the sealed reaction chamber to a desired concentration,
(2) applying the aggressive medium to the waste for a time sufficient to cause (i) at least some separation of the one or more polymers from their associated elements, and (ii) at least some breakdown of the one or more polymers to form fragments including crumb, and
(3) passing the product of step 2 through the riddle such that at least some of the associated elements are retained within the riddle.

In a sixth embodiment the present invention provides a process for processing waste comprising one or more polymers and associated elements, the device comprising;
(1)(a) loading preliminarily deformed waste into a riddle,
(1)(b) locating the riddle within a reaction chamber,
(1)(c) hermetically sealing the reaction chamber,
(1)(d) admitting an aggressive medium into the reaction chamber to a desired concentration,
(1)(e) applying additional deformation to the preliminarily deformed waste inside the reaction chamber,
(2) applying the aggressive medium to the waste for a time sufficient to cause (i) at least some separation of the one or more polymers from their associated elements, and (ii) at least some breakdown of the one or more polymers to form fragments including crumb, and
(3) passing the product of step 2 through a riddle such that at least some of the associated elements are retained within the riddle.

In a seventh embodiment the present invention provides a device for processing waste comprising one or more polymers and associated elements, the device comprising;
a reaction chamber,
a system for admission and control of aggressive medium to the reaction chamber,
wherein in use, preliminarily deformed waste is loaded into the reaction chamber, aggressive medium is admitted to the reaction chamber and safely controlled together with present polymeric dust for a time sufficient to separate one or more polymers into fragments and cause separation of the one or more polymers from at least some of their associated elements, and the fragments are removed from the reaction chamber.

In a eighth embodiment the present invention provides a device for processing waste comprising one or more polymers and associated elements, the device comprising;
a reaction chamber,
a riddle,
a system for admission and control of aggressive medium to the reaction chamber,
wherein in use, preliminarily deformed waste is loaded into the reaction chamber, aggressive medium is admitted to the reaction chamber for a time sufficient to separate one or more polymers into fragments and cause separation of the one or more polymers from at least some of their associated elements, before the fragments are passed through the riddle, the riddle retaining at least some separated associated elements.

In a ninth embodiment the present invention provides a device for processing waste comprising one or more polymers and associated elements, the device comprising;
a reaction chamber,
a hermetically sealable casing enclosing the reaction chamber,
a riddle,
a system for control of the flow of aggressive medium to the reaction chamber,
a mechanism for applying deformation to waste located within the reaction chamber,
wherein in use, preliminarily deformed waste is selectively loaded into the reaction chamber within the sealable casing, an aggressive medium is admitted to the reaction chamber under system control, applying additional deformation to the preliminarily deformed waste inside the reaction chamber, for a time sufficient to breakdown one or more polymers into fragments, and cause separation of the one or more polymers from at least some of their associated elements, then passing the fragments through a riddle, the riddle retaining at least some separated associated elements.

In a tenth embodiment the present invention provides a device for processing waste comprising one or more polymers and associated elements, the device comprising;
a reaction chamber divided into sub-chambers,
a hermetically sealable casing for enclosing the reaction chamber,
a riddle associated with each sub-chamber,
a system for control of flow of aggressive medium to the reaction chamber,
wherein in use, preliminarily deformed waste is loaded into the sub-chambers, the casing is sealed and aggressive medium is admitted into one or more sub-chambers for a time sufficient to breakdown one or more polymers into fragments, and cause separation of the one or more polymers from at least some of their associated elements, then passing the fragments from the sub-chambers through their associated riddle, the riddles retaining at least some separated associated elements.
   Thus, the reaction chamber may be partitioned into two or more separate sub-chambers. This provides the option of loading each sub-chamber with the same or different qualities or types of waste for simultaneous processing.

Typically the riddle associated with the reaction chamber is mobile and can be moved between a first position exterior to the reaction chamber, and a second position inside the reaction chamber. The reaction chamber may additionally have a casing. The reaction chamber and/or the riddle may also able to be rotated within the sealable casing, or rotated in addition to the sealable casing. The rotation of these components can be achieved using commonly available drive mechanisms.

Typically the system for admission and control of aggressive media comprises feed lines, inlet and outlet ports with associated pipe sockets communicating with the reaction chamber or casing, valves, pumps and other mechanical devices readily apparent to the person skilled in the art. The system may be under manual control, computer control or a combination of the two.

Typically the system includes a pump for forcing a flow or suction of air, or applying a partial or full vacuum to the reaction chamber. The air flow or vacuum can assist in sweeping out any dirt, dust or other unwanted particulate matter on the polymer.

The device may further include elements, such as solid and/or grilled or latticed weights, for further deformation of the polymer waste during processing operating under gravity, or operated by pneumatic, electromagnetic, ultrasound or other convenient actuation means. The elements may further comprise, for example, pneumatic pistons or spring loaded mechanisms such as rams or strips which can be made from the same polymeric type material that is being processed by the present invention.

The device preferably includes a safety control system for minimising the likelihood of explosion. Typically the safety control system includes detectors which communicate with a monitoring system to provide information such as the composition and pressure of an aggressive medium at various locations in the device, the partial pressure and concentration of, for example, an aggressive gas and the levels of dust and other particulate matter. Furthermore, explosion containment elements may be located adjacent the walls of the reaction chamber to absorb or contain energy, shock-waves or debris emitted as a result of a detonation.

The device may also include other safety systems such as a spark prevention control system to prevent sparks and static electricity within the device.

The device of the present invention may be constructed as a fixed stationary device, or can be made mobile by being mounted on a land vehicle, rail carriage or sea going vessel.

Advantages Provided by the Present Invention Comprise the Following: a method based on simple technology;
simple construction parameters apply to the device;
reduced mechanical force and associated reduced energy consumption of the technology, wherein any additional deformation of polymeric waste required during contact with the aggressive medium can be employed via energy efficient means to further induce the fragmentation of the polymer and its separation from the reinforcing elements;
reduced volume and concentration levels of aggressive medium can be used in comparison the prior art;
the concentration of aggressive medium used can be are matched to different qualities of rubber waste;
the number of input and output lines for the aggressive medium can be minimised thus increasing safety by reducing the risk of gas leakage, simplifying the explosion-proofing of the device, allowing drivers to be located exterior to the aggressive medium to reduce the possibility of a spark causing an, explosion;
increased fragment quality due to the ability to selectively process different qualities of polymer;
increased productivity, as the reaction chamber or sub-chambers of the device can be loaded with any required volume of waste, the volume being constrained only by the size of the reaction chamber or sub-chamber; and
reduced processing costs due to the comparatively simple construction parameters for the device and more economical usage of aggressive medium.

Compatibility with Other Processes

The process and device of the present invention may be used in combination with other up-stream or down-stream processes.

For example, the feedstock may include tyres segmented as described in Australian standard patent AU2006241342 and subsequent International patent application WO2008/061285. Tyre feedstock, including tyre segments, may be deformed in the manner describe in Australian provisional patent application AU2009904193.

The products of the present invention may, for example, be provided as feedstock for the extrusion process described in Australian provisional patent application AU2009903685 and subsequent Patent Cooperation Treaty application PCT/AU2010/000284.

Further scope of applicability of embodiments of the present invention will become apparent from the detailed description given hereinafter. However, it should be understood that the detailed description and specific examples, while indicating preferred embodiments of the invention, are given by way of illustration only, since various changes, and modifications within the spirit and scope of the disclosure herein will become apparent to those skilled in the art from this detailed description.

### BRIEF DESCRIPTION OF THE DRAWINGS

The present invention will now be described with reference to the figures of the accompanying drawings, which illustrate particular preferred embodiments of the present invention, wherein:

FIG. 1 is a side view of the waste disposal device depicting separately the hermetically sealable casing and, the reaction chamber incorporating a riddle, prior to the loading of the reaction chamber into the hermetically sealable casing.

FIG. 2 is a sectional side view of the waste disposal device depicting the reaction chamber incorporating the riddle after it has being loaded into the hermetically sealable casing.

FIG. 3 is a sectional side view of an embodiment of the waste disposal device wherein the reaction chamber incorporating a riddle is positioned and enclosed within the hermetically sealable casing prior to being loaded.

FIG. 4 is an axonometric view of a segment of rubber waste comprising the tread of a tyre, maintained in a preliminarily deformed state prior to loading into the riddle in the reaction chamber.

FIG. 5 is an axonometric view of a segment of rubber waste comprising the bead of a tyre, maintained in a preliminarily deformed state prior to loading into the riddle in the reaction chamber.

FIG. 6 is an axonometric topside view of rubber waste segments maintained in a preliminarily deformed state inside a flexible mesh bag prior to loading into the riddle in the reaction chamber.

FIG. 7 is a front view of one embodiment of a device according to the present invention.

FIG. 8 is a top view of the device depicted in FIG. 7.

### DETAILED DESCRIPTION

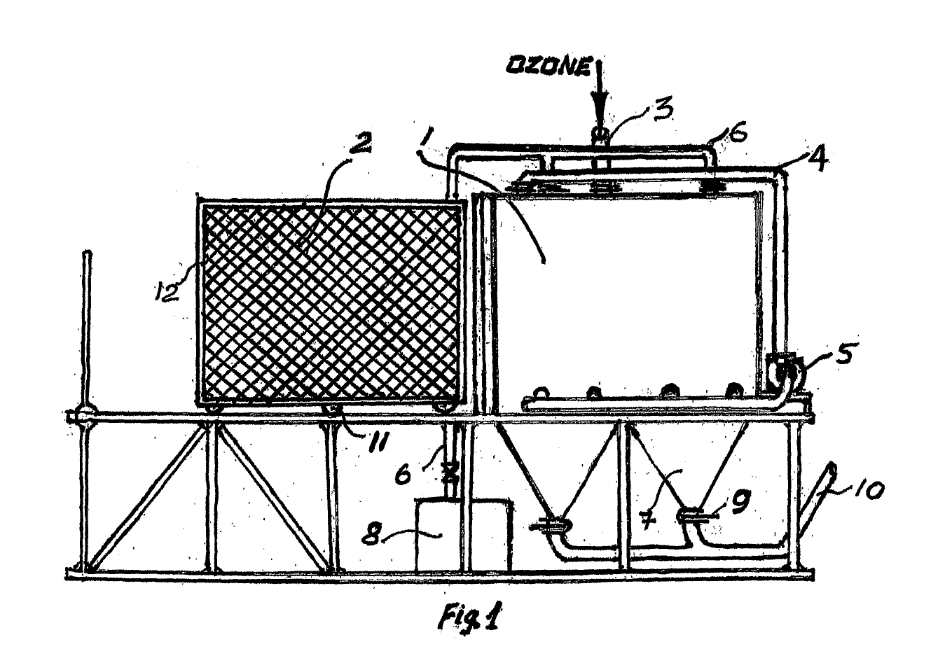

FIG. 1 depicts an embodiment of the waste disposal device with two distinct compartments constructed from or coated with a material that is resistant to the aggressive medium used in the process. The reaction chamber comprises a hermetically sealable casing 1 and a riddle 2. In this embodiment the riddle 2 is mobile and can be moved into the hermetically sealable casing 1. In this embodiment, the polymeric waste is loaded into the riddle 2 through, for example, an open port at the top of the riddle 2, prior to moving the riddle 2 into the hermetically sealable casing 1. Preliminary deformation of the polymeric waste can be carried out either outside or inside the riddle 2, prior to the application of the aggressive medium inside casing 1. Once loaded with the preliminarily deformed polymeric waste the riddle 2 is positioned inside the casing 1 which is then hermetically sealed. The aggressive medium can then be circulated within the hermetically sealed casing 1 where it diffuses through the riddle and becomes evenly distributed through the hermetically sealed casing 1 and riddle 2.

In one variation of this embodiment of the polymeric waste disposal device, the mobile riddle 2 is also able to be rotated or otherwise displaced via additional elements (not shown) within the hermetically sealable casing 1. This movement adds to any necessary additional deformation of the polymeric waste segments once the casing 1 is hermetically sealed and filled with aggressive medium to assist conversion of the polymeric waste segments into fragments.

At a more detailed level, FIG. 1 shows a pump 8 which incorporates an oil filter. The pump 8 can operate via pipe-socket 6 to blow air onto the loaded rubber waste pieces to clean them of dirt and dust either outside or inside of casing 1. In the case where cleaning is elected to be conducted inside casing 1, it is carried out prior to the admission of the aggressive medium. The air bearing the dirt and dust can be evacuated via collectors 7 and passed on through pipe feed line 10. During this cleaning process the seal connecting pipe 4 to the hermetically sealable casing 1 is closed whilst other seals (such as the seal 9, which connect the depicted collectors 7 with pipe feed line 10) are open.

FIG. 1 also shows a ventilation device 5 which is initially utilised to evacuate the casing 1 in order to more quickly attain the necessary concentration of aggressive medium inside the hermetically sealed reaction chamber. As the casing 1 of the hermetically sealed reaction chamber is evacuated, the seal connecting pipe 4 to the hermetically sealable casing 1 is preferably closed. Other seals are also preferably closed (such as the seal 9, which connect the collectors 7 with pipe feed line 10), whilst yet other seals are preferably open (such as the seal (not shown) which connects pipe 4 with pipe feed line 10). The ventilation device 5 can also evacuate air with particles and/or aggressive medium out of casing 1 via a sealable pipe-socket (not shown) for cleaning and/or degradation as necessary.

The hermetically sealable casing 1 also includes a pipe-socket 3 for admission of the aggressive medium, and a pipe 4 for the circulation of the said aggressive medium via a ventilation device 5. Once the necessary concentration of aggressive medium inside the hermetically sealed reaction chamber is achieved it can be recirculated. In this mode of operation, pipe-socket 3 to the hermetically sealable casing 1, pipe-socket 6 from the pump 8 to the hermetically sealable casing 1, and collectors 7 with pipe feed line 10, are closed.

The waste disposal process carried out in the device depicted in FIG. 1 produces fragments. In one variation of this embodiment, in order to provide total evacuation of the contents in casing 1 if required, the pump 8 blows air along the pipe-socket 6 to transport the resultant fragments and clear out the remaining aggressive gas from the casing 1 and riddle 2. The polymeric fragments, including crumb, and associated aggressive medium are transported out of the device via the depicted collectors 7 and on through a pipe feed line 10 when the associated seals such as seal 9, are opened. The polymeric fragments, including crumb, can be transported to other processing devices such as cyclonic separators and degradation devices (not shown).

In another variation of this embodiment, pump 8 is directly connected via another pipe-socket to an intermediate holding vessel (not shown) for the polymeric: fragments, preferably situated underneath collector 7 and being connected via seal/slide 9, being closed in this instance, thus enabling pump 8 to more easily blow the polymeric fragments out of the intermediate holding vessel through a pipe-socket (not shown) which connects via a seal to pipe-socket 10.

In yet another variation of this embodiment, instead of utilising a pneumatic system that is associated with pump 8, other transportation systems can be utilised to transport the polymeric fragments away from the reaction chamber from the collector 7, such as utilising for example screw, auger and/or conveyor type transporting devices.

All the pipe-sockets in FIG. 1 are actively separated as required when in use by seals which are illustrated but not all numbered.

FIG. 1 also depicts the riddle 2 as having wheels or rollers 11 to enable it to be moved into the hermetically sealable casing 1 which has associated directional rails (not shown). In one variation of this embodiment, the riddle 2 can be transported into the casing 1 via a loading device such as for example a fork lift.

In another variation of this embodiment, the reaction chamber 2 is fitted with or contains ballast weights (not shown) that are resistant to the aggressive medium for any additional deformation required of the waste polymer segments.

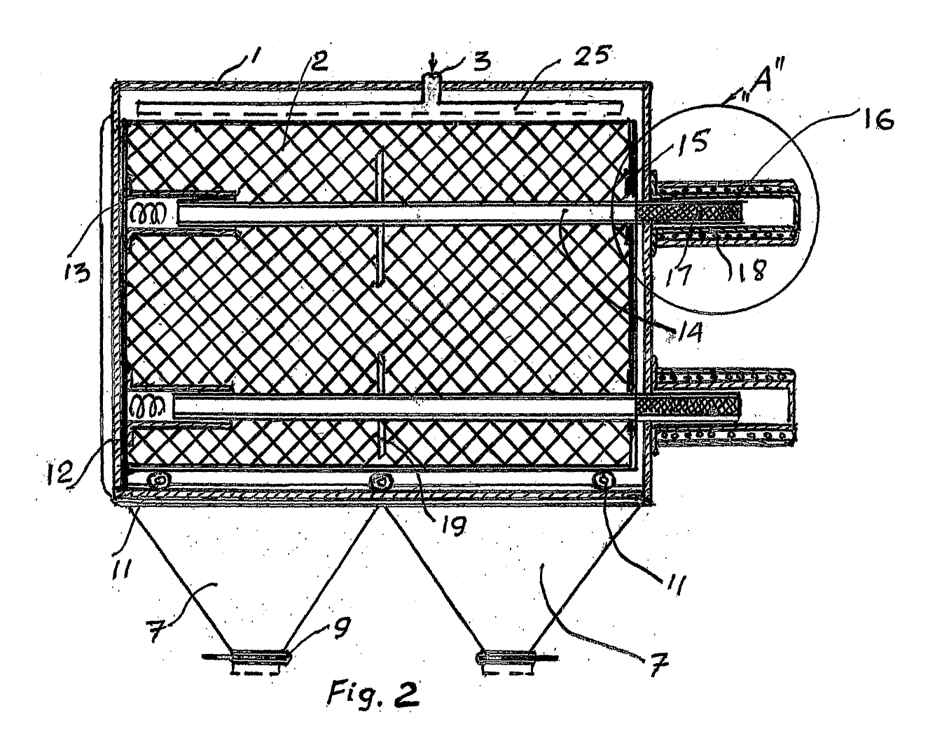

FIG. 1 also illustrates the position of the distal wall 12 of the riddle 2 in relation to the hermetically sealable casing 1 for orientation purposes. More detail of the riddle 2 is shown in FIG. 2.

In yet another variation of this embodiment, the riddle 2 can be transported through a sluice device (not shown) into and out of the casing 1.

In other variations of this embodiment, other devices may be installed in the riddle 2 to further facilitate the conversion of waste to polymeric fragments such as, for example, a vibration device or an ultra-sound device (not shown). Such devices can be encapsulated in hermetically sealed capsules which can be suspended within the riddle 2 so as to provide oscillation for additional deformation of the polymeric pieces during the action of the aggressive medium as necessary.

FIG. 2 depicts one embodiment of the riddle 2 incorporating wall 12, opposing wall 15 and branch-pipes 13 and 16 protruding outwardly from the respective walls. The branch-pipes 13 and 16 house between them a mobile pipe 14 with a ferro-magnetic core 17 which slides into branch-pipe 16. Branch-pipe 16 has externally mounted electro-magnetic inductors 18, with the resultant electro-magnetic drive depicted as ‘A’. The electromagnetic drive enables a push/pull control for the mobile pipe 14 for any required additional deformation of the waste segments. This electromagnetic drive can be substituted by other drives, such as for example, a pneumatic drive.

Plates 19 of various geometric shapes and sizes are attached at different angles to the mobile pipes so that the plates 19 from different mobile pipes 14 may further deformed the waste polymer pieces between them and provide shearing force as necessary to assist with any required additional deformation of the preliminarily deformed polymeric waste pieces and mechanical separation of any partially fragmented polymers resulting from the reaction with the aggressive medium. It is noted that for clarity FIG. 2 does not depict all the pipe-sockets depicted in FIG. 1.

In another variation of this embodiment of the riddle 2, at least one wall, for example wall 12, is mobile. The polymeric waste can thus be subjected to further additional deformation if required by moving wall 12 towards its opposing wall via, for example, a screw device (not shown), preferably prior to moving the riddle 2 into the hermetically sealable casing 1.

In another variation of this embodiment of the riddle 2, at least one wall, for example wall 12, can be so constructed as to carry out the function of a door to the riddle 2 if required.

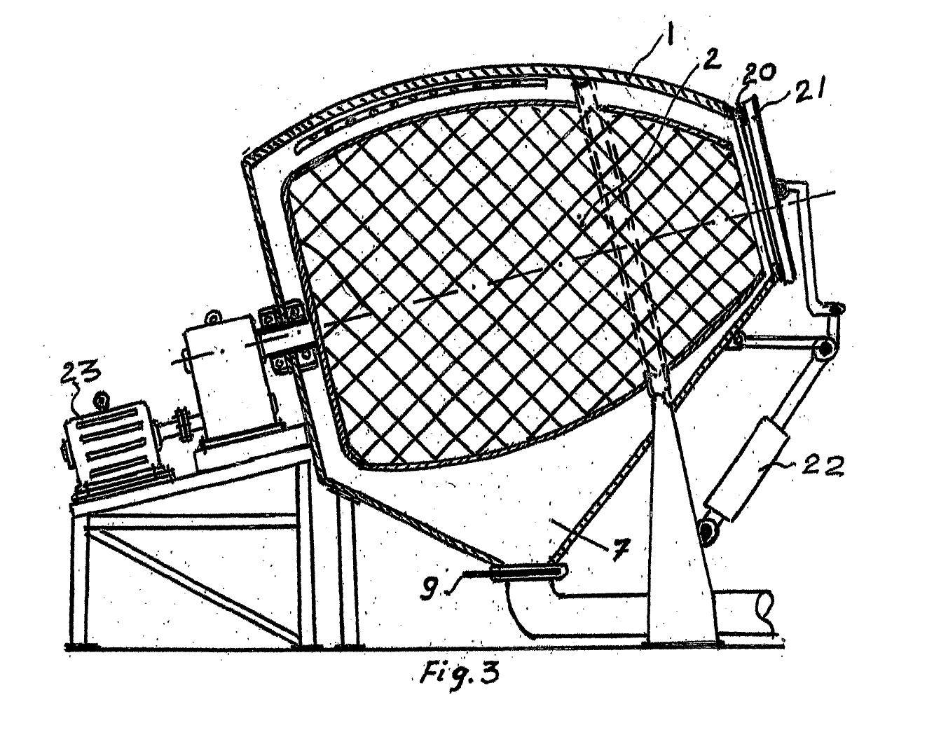

FIG. 3 depicts one embodiment of the waste disposal device where the riddle 2 is permanently fixated inside the hermetically sealable casing 1 and is rotated inside the casing 1 once it is hermetically sealed and filled with an aggressive medium (not shown). The waste polymer, having undergone preliminary deformation outside the reaction chamber is loaded via door 21. The door 21 is closed to seal casing 1 by the action of driver 22, being for example a hydraulic mechanism, and operation of gasket 20 which enables hermetic sealing. The waste polymer then undergoes additional deformation as required as a result of the riddle 2 rotating in a specified direction during and/or after an aggressive medium is applied to the waste polymers via for example a pipe-socket (not shown). The rotation of the riddle 2 is enabled by driver 23, being for example an electric drive, and is continued for as long as necessary for the effectiveness of the fragmentation reaction.

In one variation of this embodiment, the riddle 2 incorporates protrusions (not shown) that extend internally to assist with any required additional deformation of the preliminarily deformed polymeric waste pieces and mechanical separation of any partially fragmented polymers resulting from the reaction with the aggressive medium.

Preferably, the distance between door 21 and the proximal opening butt end of riddle 2 is less then the size of the polymeric waste pieces loaded into the riddle 2 so as to prevent the said pieces falling through to the collector 7 prior to undergoing the required fragmentation reaction.

At the conclusion of the required fragmentation reaction between the polymeric waste and the aggressive medium and after clearance of the aggressive medium from the reaction chamber via for example a pipe-socket (not shown), door 21 is opened by the action of driver 22, and release of pressure on gasket 20 occurs, to enable unloading of the reaction products by for example rotating riddle 2 in the opposite direction, using driver 23, being for example an electric drive.

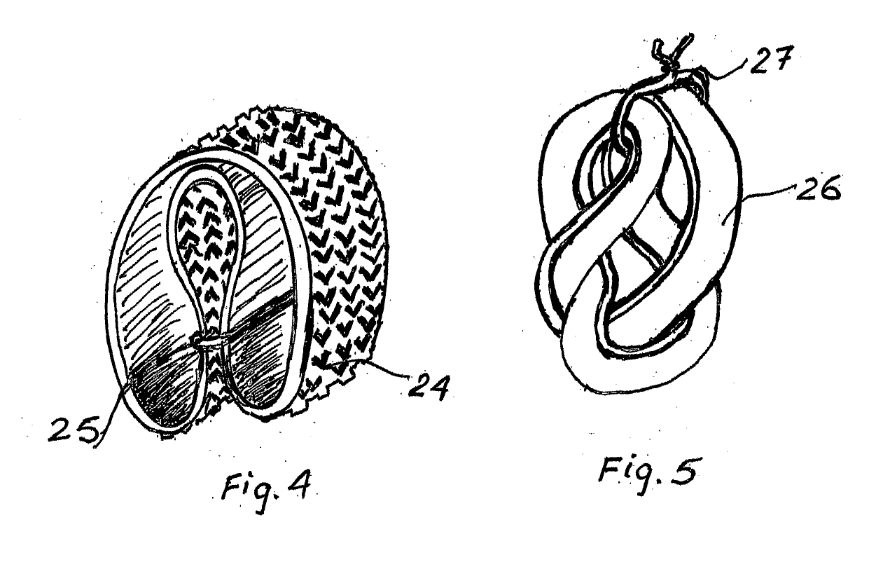

FIG. 4 depicts one variation of a preliminarily deformed soft rubber waste polymer piece 24, for example waste tyre tread. The waste polymer piece 24 is fixed by a fastener 25 made of, for example, wire.

FIG. 5 depicts one variation of a preliminarily deformed hard rubber waste polymer piece 26, for example hard rubber adjacent the bead of a waste tyre. The waste polymer piece 26 is fixed by a clip 27 made of, for example, wire.

Fixation of the deformed forms of rubber waste polymer piece such as those depicted in FIG. 4 and FIG. 5 for input into the polymeric waste processing device can be enabled by devices such as staplers, nail guns and the like.

The resultant fixated geometric form of the preliminarily deformed pieces can be of various shapes which preferably enable access of the aggressive medium to a maximum surface area of the preliminarily deformed piece that is under stress and strain. For example, the geometric shapes can be in a clover-leaf type arrangement, such as four-leaf or three-leaf clover shapes, or a spiral and/or curl-like arrangement.

Both the soft waste rubber pieces 24, and the hard waste rubber pieces 26, initially undergo low force energy efficient preliminary deformation prior to being loaded into the riddle 2. Subsequently, pieces 24 and 26 give themselves to further relatively low force additional deformation, if necessary, during the reaction with an aggressive medium which can be achieved by energy efficient means. Further, the geometric shape of pieces 24 and 26 provide for a more optimal access for the aggressive medium to the polymer in order to facilitate fragmentation. The preliminary deformation of pieces 24 and 26 is also easily automated to enable fixation via fasteners such as 25 and 27.

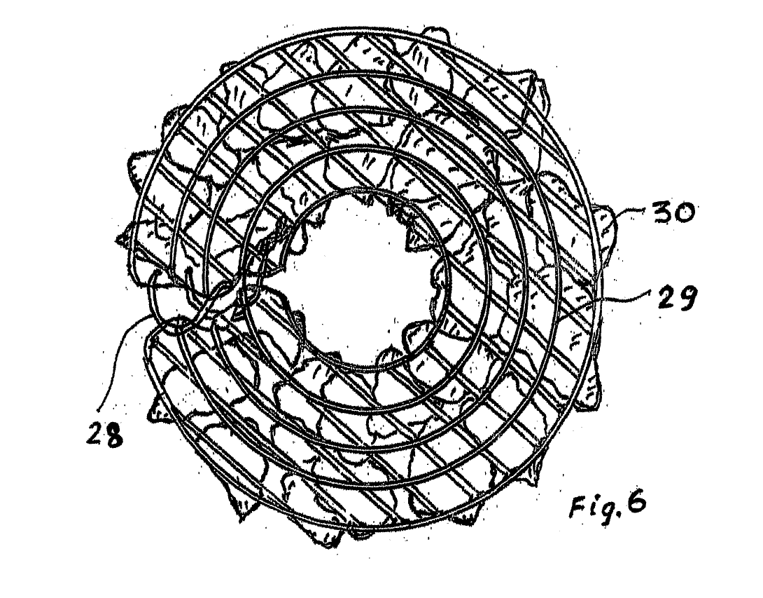

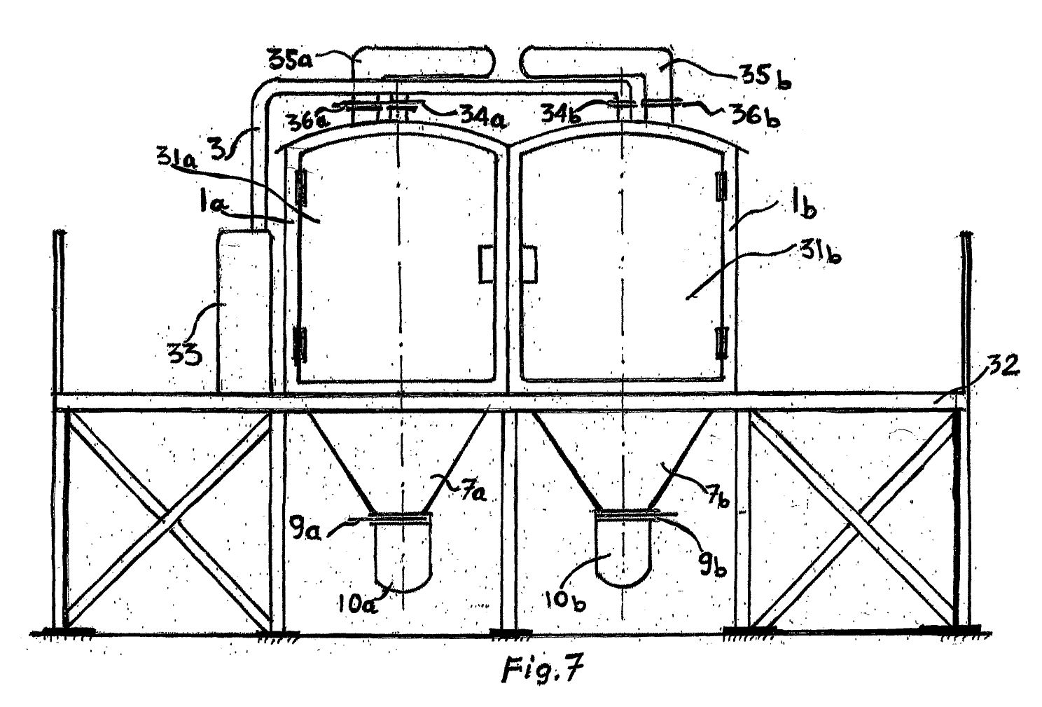

FIG. 6 depicts a further variation of preliminarily deformed waste polymer segments 30, when soft and hard rubber pieces are mixed together, for example shredded landfill composed of used tyres or used conveyer belts,. obsolete gas masks, etc. The said waste polymer segments 30 are placed into a porous bag 29 made of mesh or mesh like material, and the bag 29 is twisted to preliminarily deform the waste polymer segments 30 inside. The bag 29 is then fixed in its twisted form by a fastener 28 made of, for example, wire. The fixed bag 29 is then placed into the riddle 2 for processing.

In one, embodiment, the fixed bag 29 can be placed directly into the reaction chamber within which riddle 2 is fixated internally. The person skilled in the art would appreciate, when the said waste polymer segments 30 are shredded pieces of landfill tyres or conveyer belts, the waste polymer segments 30 would need to undergo a thorough cleaning process prior to beginning the herein described reaction with the aggressive medium. This ensures the quality of the resultant rubber fragments produced using the waste disposal device.

The fasteners 25, 27 and 28 in FIG. 4, FIG. 5 and FIG. 6 respectively, may be made from a material which under the influence of the aggressive medium is fragmented prior to the conversion of the waste polymer segments to fragments, including crumb. For example, the fasteners can be made from polymeric material strips which will first fragment as part of the reaction with the aggressive medium, thus also enabling the preliminarily deformed polymeric pieces to undergo further stress and strain caused by unwinding from their fixated geometric form and therefore at the same time enabling the aggressive medium to also access such newly stressed/strained surface area of the said polymeric pieces.

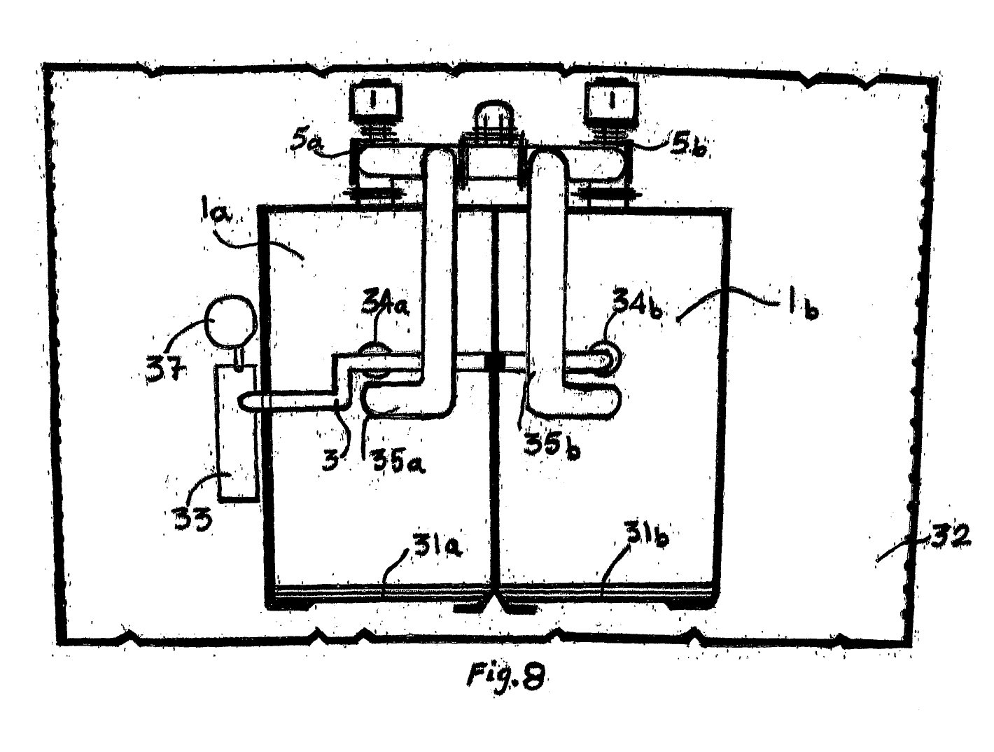

FIG. 7 is a front view of one embodiment of a device according to the present invention. In this embodiment the device includes a reaction chamber partitioned into two sub-chambers 1a, 1b. The reaction chamber is mounted on a raised platform 32. The reaction chamber comprises a casing accessed via doors 31a, 31b in each of the sub-chambers 1a, 1b. Thus each sub-chamber can be separately accessed and loaded with different or the same type of waste.

An ozone generator 33 provides a source of aggressive gas which is delivered through a pipe 3 to valves 34a, 34b which control admission of the gas through ports into each of the sub-chambers 1a, 1b. Pipes 35a, 35b permit circulation of ozone between the sub-chambers 1a, 1b controlled by valves 36a, 36b at ports in the sub-chambers. Using these pipes and valves the concentration of ozone gas in the sub-chambers 1a, 1b can be controlled.

Fragments of ozone-processed polymer can pass through a riddle (not shown) in the bottom of the sub-chambers and fall into a collector 7a, 7b. Upon opening a valve 9a, 9b in each collector the fragments pass through into pipes 10a, 10b via which they can be transported to downstream processing.

FIG. 8 is a top view of the device depicted in FIG. 7. In this view can be seen the reaction chamber with its two sub-chambers 1a, 1b mounted on a raised platform 32. In this embodiment, the oxygen supply 37 for the ozone generator 33 can also be seen. Pipe 3 transports the ozone gas to valves 34a, 34b which control admission of the gas through ports into each of the sub-chambers 1a, 1b. Pipes 35a, 35b permit circulation of ozone between the sub-chambers 1a, 1b. Ventilators 5a, 5b are used to circulate gas or evacuate sub-chambers 1a, 1b.

1. A method for processing waste comprising one or more polymers and associated elements, the method comprising the steps of;
(1) loading preliminarily deformed waste into a reaction chamber;
(2) applying an aggressive medium to the waste for a time sufficient to convert the one or more polymers to fragments, and separate one or more polymers from their associated elements; and
(3) subjecting the products of step 2 to mechanical separation of the associated elements from the polymer fragments.

2. A method according to claim 1 wherein the mechanical separation is carried out by passing the products of step 2 across a riddle such that at least some of the associated elements are retained on the riddle.

3. A method according to claim 1 wherein the reaction chamber is partitioned into two or more sub-chambers.

4. A method according to claim 1 wherein the reaction is carried out via a battery of reaction chambers being operatively connected in their use of the applied aggressive medium.

5. A method according to claim 3 wherein a riddle is associated with each reaction chamber.

6. A method for processing waste comprising one or more polymers and associated elements, the method comprising the steps of;
(1)(a) loading preliminarily deformed waste into a riddle associated with a reaction chamber;
(2) applying an aggressive medium to the waste for a time sufficient to cause (i) at least some separation of the one or more polymers from associated elements, and (ii) at least some breakdown of the one or more polymers to form fragments including crumb; and
(3) passing the product of step 2 through the riddle such that at least some of the associated elements are retained within the riddle.

7. A method according to claim 6 which additionally includes the steps of;
(1)(b) hermetically sealing the reaction chamber; and
(1)(c) admitting an aggressive medium into the sealed reaction chamber to a desired concentration.

8. A method according to claim 6 wherein step 1 additionally includes removing loose particulate matter from the reaction chamber to at least partially clean the preliminarily deformed waste.

9. A method according to claim 6 wherein step 2 additionally includes controlling the volume of aggressive medium in the reaction chamber by respective application of a partial or full vacuum or admission of air.

10. A method according to claim 6 wherein the fragments passing through the riddle are collected and graded according to particle size.

11. A method according to claim 1 wherein the aggressive medium is chosen from the group comprising ozone, oxygen, halogens, acids, alkalis, oxidising agents or combinations thereof, in gaseous, liquid or solution form.

12. A process for manufacturing a fragmented product from waste comprising one or more polymers and associated elements using the method of claim 1.

13. A device for processing waste comprising one or more polymers and associated elements, the device comprising;
a reaction chamber,
a system for admission and control of aggressive medium to the reaction chamber,
wherein in use, preliminarily deformed waste is loaded into the reaction chamber, aggressive medium is admitted to the reaction chamber and safely controlled together with present polymeric dust for a time sufficient to separate one or more polymers into fragments and cause separation of the one or more polymers from at least some of their associated elements, and the fragments are removed from the reaction chamber.

14. A device according to claim 13 which further comprises a riddle and in use, the fragments are passed through the riddle while some separated associated elements are retained by the riddle.

15. A device according to claim 14 which further comprises a system for control of the flow of the aggressive medium to the reaction chamber.

16. A device according to claim 13 wherein the reaction chamber comprises two or more sub-chambers.

17. A device according to claim 13 wherein the reaction is carried out via a battery of reaction chambers being operatively connected in their use of the applied aggressive medium.
